(19) United States
(12) Patent Application Publication
(10) Pub. No.: US 2006/0161600 A1
(43) Pub. Date: Jul. 20, 2006

(54) Elective logging

(75) Inventor: Marco Renz, Hinrichshagen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/333,609

(22) Filed: Jan. 17, 2006

(30) Foreign Application Priority Data
Jan. 18, 2005 (EP) 05000936.4

(51) Int. Cl. G06F 17/30

(52) U.S. Cl. 707/202

(57) ABSTRACT

In a system which comprises at least two log files L, data A,B,C,D is stored electively either in no log file, in a single log file or in both log files. By using parallel storage of selected data in a plurality of log files it is a simple matter to correlate the data in these log files with one another. It is possible to generate a plurality of different log files which fully satisfy different requirements on the contents of the log file in each case. In a system which comprises at least two log files L, data A, B, C, D is stored electively either in no log file, in a single log file or in both log files. By using parallel storage of selected data in a plurality of log files it is a simple matter to correlate the data in these log files with one another. It is possible to generate a plurality of different log files which fully satisfy different requirements on the contents of the log file in each case.

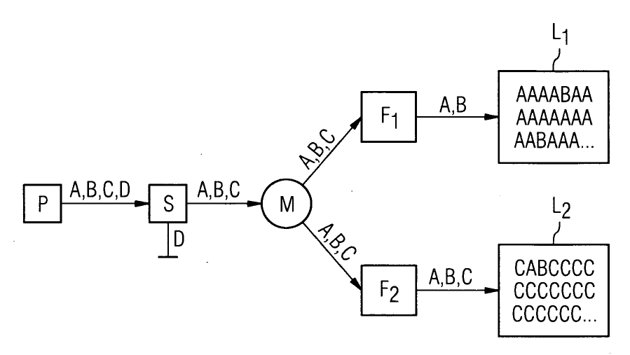

### CROSS REFERENCE TO RELATED APPLICATIONS

This application claims priority of European application No. 05000936.4 EP filed Jan. 18, 2005, which is incorporated by reference herein in its entirety.

### FIELD OF INVENTION

This invention relates to a method and apparatus for electively logging data.

### BACKGROUND OF INVENTION

The international standard M.3010 (02/2000) published by the ITU-T describes a reference architecture for a Telecommunications Management Network (TMN) for monitoring and controlling a network for telecommunications applications, in which it is assumed that the network controlled by the TMN includes different types of network elements which are normally controlled with the aid of different communications mechanisms (in other words protocols, messages, management information—also referred to as object model).

This TMN comprises the following functionalities:
Operations Systems Function (OSF) which implements the “actual” management of the telecommunications network.
Workstation Function (WSF) which serves to represent the control events and the network status for a human user of the TMN.
Network Element Function (NEF) which represents an interface for controlling the telecommunications functions of the network elements. The interface defines the specific communications mechanism of the respective network element, which may not be standardized. The sum of all management information of the NE is designated as the Management Information Base (MIB) of the NE. It is also referred to as NE-MIB in the following.
Transformation Function (TF) which is added to the TMN in order to connect components with different communications mechanisms and in particular in order to interface network elements which have no standardized NEF. It is also referred to in the M.3010 (05/96) standard as Mediation Function or Q-Adaption Function.

Furthermore, the functionalities are, as far as possible, classified into the following groups in accordance with the FCAPS schema:
F=Fault
C=Configuration
A=Accounting
P=Performance
S=Security

The functions are implemented by concrete items—also referred to as products—which can be embodied for example as network element (NE), operations system (OS), terminal, router, switch or database server, but which are naturally not restricted to these products.

The products can also be developed as computer program products (also referred to as program, application or software) which are executed by hardware (at least one processor, for example) which forms the visible, concrete execution environment for the products. This execution is frequently supported by support software (for example multitasking or multithreading operating system, database system, Windows system).

The NEF function is normally associated with an NE whereas the OSF and WSF functions are usually associated with an OS. A large number of NEs are normally associated with one OS, in which situation the OS is normally centralized whereas the NEs are distributed decentrally in the network over a large number of locations.

As a result of the standardized interface and sequences it is particularly easy to implement and sell an overall system standardized in this manner not only as an integrated product but also as a system comprising a plurality of products implemented and sold separately by different manufacturers, products which each perform a part of the standardized overall functionality and interact in such a manner that the same functionality is implemented in total as in the case of an integrated implementation of the standardized functionality. The products can for example be embodied as management applications for controlling different network technologies of a communications network, from which in each case one application-specific subset of the resources of the network, relevant to the controlled technology in each case, is modeled, visualized and controlled. They are however not restricted to products for communications systems.

The translation of the described architecture into concrete solutions presents complex technical problems as a result of the distributed nature of the system and the large number of different system components and requirements.

### SUMMARY OF INVENTION

An object of the invention is to recognize at least one of the existing problems and to solve it by specifying at least a directive for technical actions.

The invention is based on the following knowledge:
Troubleshooting in a distributed system is especially difficult because faults which manifest themselves in a system component may have their cause not only locally but also in remote components or in the transfer process between the systems.
In addition, the reproducibility of a fault often depends not only on the local configuration of the system component in question but also on the respective states of remote system components and of the transmission network linking them. It can happen that a fault is not reproducible even given an identical state of the local system component because the exact state of the other components and in particular the timing sequence of the individual events in the overall system cannot be reproduced identically.
In order to diagnose a particular fault it is often necessary to have both the most comprehensive and detailed data possible at the time of the fault and also the longest possible view back into the past from which, for example, memory consumption, the system status and important events can be seen as well as other events which may possibly have some causative relationship with the fault under investigation.
Against this background a particular significance attaches to log files in which a log is kept of the actual events, as they are often the only reliable source from which the cause of a fault can be ascertained.
With regard to log files, there is one inherent conflict of objectives. On the one hand, it would be desirable to log all possible events in order to obtain a complete picture of the past. This results in log files which become filled extremely quickly. On the other hand, it would be desirable to collect as little data as possible in order to consume the available storage space slowly and consequently enable an extremely long view back into the past.

The known techniques do not solve the recognized problem situation or at least have undesired side-effects:
Stopping logging when a log file reaches a maximum size is a known technique. This method gives a view of the past which is limited to a particular time window which remains constant once logging has stopped.
When wrap-around technology is employed, a log file is likewise filled until it reaches a maximum size. When that occurs, however, logging is not stopped but the log file is overwritten starting again from the beginning whilst maintaining the maximum size, with the result that the oldest data is always deleted at each step by each write operation. This method thus provides a temporally limited view of the immediately preceding past.
By using filters it is possible to set the length and precision of the view back into the past. In this situation, the view of the past is either precise and thus relatively short, or imprecise and thus relatively long. It is necessary to decide prior to logging whether less data is to be stored and thus a relatively long period of time is to be covered, or whether detailed data is to be stored and thus only a relatively short period of time is to be monitored, whereby in the case of a wrap-around logging method older and possibly very important data will be overwritten relatively quickly.
The decision as to which filter is to be used cannot usually be made in advance, particularly when the cause and time of the occurrence of a fault are unknown.

A solution for the problem situation recognized according to the invention and also advantageous embodiments of this solution are set down in the claims which likewise serve to describe the invention and are therefore part of the description.

### BRIEF DESCRIPTION OF THE DRAWING

The invention will be described in the following with reference to embodiments which are also illustrated in the figures. It should be stressed that the embodiments of the invention shown, in spite of their in part extremely faithfully detailed representation, are merely of an exemplary nature and must not be understood as restrictive. In the drawing, the:

FIGURE shows an example of a solution according to the invention for the elective storage of data A, B, C, D for an application P in log files L.

### DETAILED DESCRIPTION OF INVENTION

As a solution for the problem situation recognized according to the invention the method proposes the provision of at least two log files L₁, L₂ and the storage of the data A, B, C, D for the application P electively either in no log file, in a single log file or in both log files L₁, L₂.

Particularly good advantages result here when sporadically occurring data A, B (for example internal faults A or user actions B) are stored for example in both log files L₁, L₂ and detailed and therefore more frequently occurring data C (for example function calls C) are stored only in one of the two log files L₁, L₂—for example the second log file L₂. With the aid of the first log file L₁ a relatively long but comparatively imprecise view back into the past is then enabled, and with the aid of the second log file L₂ a view back is enabled which although shorter is accordingly more precise. With the aid of the data A, B stored in the two log files L₁, L₂, it is possible to correlate the data A, B, C stored in the two log files L₁, L₂ in spite of its being stored in different log files L.

The optional storage of the data C in log file L₂ but not in log file L₁ is achieved for example by including a log file specific filter F in each case upstream of each of the two log files L, whereby the data A, B, C is fed to each of the filters F, which results functionally in the implementation of a multiplexer M. The filter F₁ associated with the log file L₁ is configured such that only the data A, B and not the data C and also not the data D is stored in the log file L₁. The filter F₂ associated with the log file L₂ on the other hand is configured such that with the exception of the data D all the data A, B, C is stored in the log file L₂.

By preference, the data D which is not stored is intercepted by a summing filter S included upstream of the multiplexing onto the filters F and is not fed to the filters F. This spares the work involved in first feeding the data D to each of the filters F only to then decide on an individual basis for each filter F that the data D is not to be stored after all.

With regard to this embodiment, at least the second log file L₂ is preferably operated in a wrap-around mode since it can become extremely large comparatively quickly on account of the detailed data C. The second log file L₂ continues to fill until the fault to be investigated has occurred. Logging is stopped immediately thereafter. In this way a very up-to-date view of the past immediately prior to the occurrence of the fault is presented.

Alternatively, the data A, B can be stored in both log files L₁, L₂, the data C only in log file L₁ and the data D only in log file L₂. This therefore advantageously allows essentially complete log files L to be created for different faults which are usually analyzed by different teams. There is no need for either a subsequent correlation of a plurality of log files L or a prior agreement as to which log files are to be created.

In the following an embodiment of the invention is described in which the invention takes the form of a computer program product in which the data A, B, C, D for an application P is stored according to the invention in log files L. In order to facilitate readability the application P is reproduced not as a machine program but as C program code, as a result of which the invention is naturally not restricted to the representation. The explanations for the invention are inserted into the C program code as comments identified by “//”.

With regard to this embodiment, the application P is organized such that the data A, B, C, D is permanently traced. This has the advantage that no recompilation of the application P is required in order to active and deactivate tracing. On the other hand, it is desirable to implement the elective logging with a minimum resource requirement in order that the execution of the computer program product is not slowed down excessively by the multiplicity of trace statements contained in the application P.

//---------------------------------------------------------
// Application P.cpp
//---------------------------------------------------------

void P::P( )

{

// Example of the call for a trace:
// The first two arguments serve to classify
// the data A,B,C,D. The next two arguments are
// the name of the class and the function. The latter
// argument contains any desired text which can be
// used for optional comments
TT_TRACE
( DID
, 7
, “P”
, “P”
, “only for demonstration purposes”
);

}

//---------------------------------------------------------
// TT_TRACE is a macro with the following program code
//---------------------------------------------------------

if ( TTInternal::isConfigured ( DID , 7 ) )

// isConfigured is a sample implementation of a summing
// filter S. A check is made as to whether at least one
// log file with Level 7 exists for the domain DID.
// If this is not the case, the following program
// code writeLine( ) is not executed and thus prevents
// data being fed to the filters F

{

TTInternal::writeLine
( DID
, 7
, _FILE_{—}
, _LINE_{—}
, “P”
, “P”
, “only for demonstration purposes”
);

}

//---------------------------------------------------------
// Sample implementation of isConfigured (...)
// (= summing filter S)
//---------------------------------------------------------

// domainId (DID) addresses an entry in m_configArray
// logLevel (7) addresses an individual bit
// domainId, logLevel and m_configArray are constants
// which are known to the compiler from the static call
// from TTInternal.
// The compiler can merely translate this into 3 Assembler
// instructions. These are inline, in other words no branch
// instructions to subfunctions are required.
bool isConfigured

( TTDefinitions::DomainId domainId
, TTDefinitions::LogLevel logLevel
) const

{

return
( 0 != ( m_configArray[domainId] & ( 1 << logLevel ) ) )
;

}

//---------------------------------------------------------
// Sample implementation of writeLine (...)
//---------------------------------------------------------

void TTInternal::writeLine

| | |
|---|---|
| ( TTDefinitions::DomainId | domainId |
| , TTDefinitions::LogLevel | logLevel |
| , TTDefinitions::LevelId | leveled |
| , TTDefinitions::TraceString | filename |
| , unsigned long | lineNumber |
| , TTDefinitions::TraceString | className |
| , TTDefinitions::TraceString | functionName |
| , TTDefinitions::TraceString | freeText |

)

{

InstanceList& instanceList = getInstanceList( );
InstanceList::iterator it;
// instanceList contains a list of all log files L
// it is an iterator which is used in the following
// loops to feed the data to all the log files L
// contained in the list.
// The loop is a possible implementation of the
// multiplexer M
for
( it = instanceList.begin( )
; it != instanceList.end( )
; ++it
)
{

TTInstance* pInstance = *it;
// A check is initially made for each log file as
// to whether it is currently actually activated.
if ( pInstance−>isActive( ) )
{

// Next a check is made using a filter F prior
// to each storage operation to a log file
// as to whether the data is to be written.
// This check is carried out depending on
// separately stored configuration files
// which serve to describe the configuration
// of the filters F.
// In the present example a storage operation
// is performed if domain DID and Level 7
// are set in the filter F
;if
( pInstance−>getConfigFile( ).isConfigured

( domainId
, logLevel
)

)
{

pInstance−>getLogFile( ).writeLine
( TTDefinitions::getDomainName(domainId)
, TTDefinitions::getLevelName(levelId)
, fileName
, lineNumber
, className
, functionName
, freeText);

}

}

}

}

When the computer program product is executed in accordance with the current prior art the configuration of the filters described in the configuration files is stored in the memory of a computer, for example. The storage space this occupies is assigned to the address space of the computer program product. Access to this configuration data stored in the memory takes place in the routine is Configured ( . . . ) by way of the statement

(m_configArray[domainId] & (1<<logLevel))

In order to allow this configuration data to be selectively changed a further application is for example provided which likewise has access to the storage space by way of a parallel thread, for example. With the aid of this application, changed configuration files are placed once again in the storage space. The consequence of this is that the changed configuration of the filters F becomes effective from the point in time at which it is stored in the memory without there being any need to interrupt the execution of the computer program product according to the invention or requiring any adaptation of the computer program product.

The invention has a large number of further advantages associated with it:
By using parallel storage of selected data in a plurality of log files it is a simple matter to correlate the data in these log files with one another.
It is possible to generate a plurality of different log files which fully satisfy different requirements on the contents of the log file in each case. This is a particularly good advantage if only a little time is available for the analysis of an application P and a plurality of faults is analyzed simultaneously. This is the case for example if the application P is already running for the customer and can only be analyzed at night because it is being used during the daytime in spite of the faults. For each fault, it is then possible to simultaneously create a plurality of families of log files during the limited time allocation, whereby each family contains all the data relevant to the respective fault. Thus it is possible to completely analyze each fault from a single family of log files. A time-consuming and complex coordination and subsequent correlation of the log files of different families is not required.
In principle, an implementation of the invention requires no changes to the previous prior art but can basically be inserted subsequently as a module—in particular as a modified or additional computer program product.
The time of implementation is not dependent on the time of implementation of other functions.
The invention ensures that there is only minimal loading on the individual components of the overall system and that the stability of the overall system is thereby enhanced.

In conclusion it should be noted that the description of the components of the system relevant to the invention should fundamentally not be understood as restrictive with regard to a particular physical implementation or assignment. For a relevant person skilled in the art it is, in particular, obvious that the invention can be implemented in part or in its entirety in a distributed fashion using software and distributed over a plurality of physical items/computer program products.

1.-10. (canceled)

11. A method for electronically logging data into a first file and a second file, comprising:
providing an option of where to store the data, the option selected from the group consisting of the first file, the first and second files, and no files.
storing a first part of the data in both log files; and
storing a second part of the data in only the second log files.

12. The method according to claim 11, wherein the data stored in the log files is correlated with aid of the data stored in both log files.

13. The method according to claim 12, wherein the second log file is operated in a wrap-around mode.

14. The method according to claim 11, wherein the data is selected from the group consisting of faults, user actions, and function calls.

15. The method according to claim 11, further comprising filtering the data via filters prior to storing the data parts, wherein the stored data parts have been filtered.

16. The method according to claim 15, further comprising preventing the data from being fed to the filters if the data is not to be stored in any of the log files.

17. The method according to claim 16, wherein the data is selected from the group consisting of faults, user actions, and function calls.

18. A computer program product for electronically logging data into a first file and second file, the product stored on a computer readable medium having instructions for executing a method, comprising:
providing an option of where to store the data, the option selected from the group consisting of the first file, the first and second files, and no files;
storing a first part of the data in both log files; and
storing a second part of the data in only the second log files.

19. The product according to claim 18, wherein the data stored in the log files is correlated with aid of the data stored in both log files.

20. The product according to claim 19, wherein the second log file is operated in a wrap-around mode.

21. The product according to claim 18, wherein the data is selected from the group consisting of faults, user actions, and function calls

22. The product according to claim 18, further comprising filtering the data via filters prior to storing the data parts, wherein the stored data parts have been filtered.

23. The product according to claim 22, further comprising preventing the data from being fed to the filters if the data is not to be stored in any of the log files.

24. A method for electronically logging data into a first file and second file, comprising:
receiving a sporadic data and a frequent data;
storing the sporadic data in the first and second files; and
storing the sporadic and frequent data in only the second file.

25. The method according to claim 24, further comprising filtering the data via filters prior to storing the data parts, wherein the stored data parts have been filtered.

26. The method according to claim 24, further comprising preventing the data from being fed to the filters if the data is not to be stored in any of the log files.
